(19) United States
(12) Patent Application Publication
(10) Pub. No.: US 2025/0273771 A1
(43) Pub. Date: Aug. 28, 2025

(54) STRETCHABLE METAL-AIR BATTERIES THROUGH SLIDING ELECTRODES

(71) Applicant: The Trustees of the University of Pennsylvania, Philadelphia, PA (US)

(72) Inventors: James Pikul, Philadelphia, PA (US); Yichao Shi, Middleton, WI (US); Muqing Ren, Schenectady, NY (US)

(21) Appl. No.: 19/056,974

(22) Filed: Feb. 19, 2025

Related U.S. Application Data
(60) Provisional application No. 63/559,083, filed on Feb. 28, 2024.
(60) Provisional application No. 63/558,076, filed on Feb. 26, 2024.

(51) Int. Cl. H01M 12/06; H01M 4/02; H01M 6/22

(52) U.S. Cl. CPC H01M 12/06; H01M 4/02; H01M 6/22; H01M 2004/023; H01M 2300/0085

(57) ABSTRACT

A flexible battery, comprising: one or more cathodes; one or more anodes; a stretchable electrolyte in ionic communication with the one or more cathodes and the one or more anodes, the stretchable electrolyte defining a cathode contact area with the one or more cathodes, the stretchable electrolyte defining an anode contact area with the one or more rigid anodes, the stretchable electrolyte optionally comprising a hydrogel; and (1) the one or more cathodes defining a sliding interface with the stretchable electrolyte, (2) the one or more anodes defining a sliding interface with the stretchable electrolyte, or both (1) and (2). A method, comprising powering a device that comprises a stretchable battery according to the present disclosure. A method, comprising effecting operation of a device that comprises a stretchable battery according to the present disclosure.

### CROSS-REFERENCE TO RELATED APPLICATIONS

This application claims the benefit to U.S. Provisional Application No. 63/559,083, filed Feb. 28, 2024; and to U.S. Provisional Application No. 63/558,076, filed Feb. 26, 2024. All foregoing applications are incorporated herein by reference in their entireties for any and all purposes.

### TECHNICAL FIELD

The present disclosure relates to the field of energy storage devices, in particular to the field of metal-air batteries.

### BACKGROUND

Soft robots and wearable technologies benefit significantly from stretchable batteries, yet the rigid nature of high-performance electrodes creates large trade-offs in performance and stretchability. Accordingly, there is a need for stretchable electrodes.

### SUMMARY

Soft robots and wearable technologies benefit significantly from stretchable batteries, yet the rigid nature of high-capacity electrodes creates large trade-offs in battery performance and stretchability. This study introduces a new approach for realizing stretchable batteries by allowing the electrodes to slide along a stretchable electrolyte. When the sliding-electrodes battery is stretched, the forces are transmitted through the hydrogel electrolyte and elastomeric enclosure, while the rigid electrodes slide relative to the hydrogel to maintain interfacial contact. The sliding-electrodes approach allows 100% of the unstretched battery area to be covered by thick electrodes so that the battery areal capacity and power are improved by up to 10× of prior stretchable designs. Three metal-air batteries achieve areal capacities of up to 104 mWh cm⁻². Further mechanical testing, electrochemical characterization, and integration into soft robotic systems demonstrate the potential of these stretchable batteries in practical applications. The sliding-electrodes battery can stably power multiple servo motors and sensing circuits under stretching, twisting, bending, and after impact.

In meeting the described long-felt needs, the present disclosure provides a flexible battery, comprising: one or more cathodes; one or more anodes; a stretchable electrolyte in ionic communication with the one or more cathodes and the one or more anodes, the stretchable electrolyte defining a cathode contact area with the one or more cathodes, the stretchable electrolyte defining an anode contact area with the one or more rigid anodes, the stretchable electrolyte optionally comprising a hydrogel; and (1) the one or more cathodes defining a sliding interface with the stretchable electrolyte, (2) the one or more anodes defining a sliding interface with the stretchable electrolyte, or both (1) and (2).

Also provided is a method, comprising powering a device that comprises a stretchable battery according to the present disclosure.

Further provided is a method, comprising effecting operation of a device that comprises a stretchable battery according to the present disclosure.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various aspects discussed in the present document. In the drawings:

FIGS. 1A-1C. Comparison of different stretchable battery designs. FIG. 1A: Finite element simulations, listed from top to bottom, show our proposed sliding-electrodes design, followed by previously reported strategies in the literature: rigid islands, stretchable matrix, and kirigami metamaterials. FIG. 1B: A 3D schematic of the sliding-electrodes stretchable battery. FIG. 1C: Comparison of the maximum battery strain, ε^{max} based on different electrode coverage ratios, φ and hydrogel electrolyte, ε_{electrolyte}^{max}=1, 3, 5, 7, 9. For sliding-electrodes batteries, φ_{sliding electrodes}=1 because the electrode can completely cover the hydrogel's surface. For rigid-islands batteries, φ_{rigid islands}=0.1, 0.3, 0.5, 0.7, 0.9 because spacing is required to achieve stretchability. The bars are color-coded as follows: Dark green (A) indicates ε^{max} below 1, teal (B) represents ε^{max} above 1, gold (C) represents ε^{max} above 3, orange (D) represents ε^{max} above 5, and purple (E) represents ε^{max} exceeding 7. Detailed data for the 3D bar chart can be found in Table 1.

FIGS. 2A-2E. Mechanical characterization of the stretchable battery. FIG. 2A: Sequential images showcasing the stretchable battery powering three servo motors at various stages: undeformed, at strain ε=0.51, a bending angle=180°, a twist angle of=180°, and post-impact from a hammer. FIG. 2B: Tensile Properties of our stretchable battery and its hydrogel electrolyte. FIG. 2C: Images of the stretchable battery at different strains, ε. The dimensions of the stretchable battery are specified as 1×w×t=65×20×6 mm. FIG. 2D: Elasticity of a thin hydrogel rope, demonstrated by its configuration in an overhand knot (left) and its elongated state under varied loads (right). FIG. 2E: Cyclic loading tests on the dog-bone-shaped hydrogel electrolyte.

FIGS. 3A-3B. Electrochemical characterization of the stretchable battery. FIG. 3A: Electrochemical impedance spectroscopy measurements of the KOH hydrogel electrolyte and sliding-electrodes batteries with different metal anodes (Mg. Zn, and Al) at ε=0.08, 0.17, 0.25, and 0.42. FIG. 3B: Discharge performance of rigid metal-air control cells with Mg, Zn, and Al anodes with 0 and 150 g (15 KPa) weights added to the top of the cells. C: Discharge performance of sliding-electrodes batteries with Mg, Zn, and Al anodes at ε=0.42. A pressure sensor inserted into the stretchable battery measured the normal stress on the electrodes.

FIGS. 4A-4F. Integration of the stretchable battery in soft robots. FIG. 4A: Image of the soft crawler with an enlarged inset showing its asymmetric feet. FIG. 4B: The crawler's locomotion driven by repeated cycles of inflation and deflation. FIG. 4C: Circuit diagram of the FSR, LED, boost converter, and stretchable battery on the soft crawler. FIG. 4D: Plot of the FSR's resistance dependence on pressure. FIG. 4E: Working voltage and areal capacity comparison of the sliding-electrodes batteries and other flexible and stretchable MABs. (Note: Not all flexible MABs are stretchable. The capacity per cycle is used for rechargeable Zn-air cells) FIG. 4F: A pneumatic Stewart platform with onboard LEDs powered by a sliding-electrodes battery.

FIG. 5. Comparison of the electrode coverage ratio, φ=electrode area/unstretched battery area, to the maximum battery strain for rigid-islands and sliding-electrodes batteries made with stretchable electrolytes. The second axis compares the stretchable-matrix design to the sliding-electrodes design by plotting the weight percentage of the electrode particles in the stretchable matrix, ψ_{stretchable matrix}, for batteries reported in the literature. ψ_{sliding electrode}=1 as the anodes are fully dense metals.

FIG. 6. Stress-strain curve of the copper screen mesh (stretchable current collector).

FIG. 7. Hydrogel electrolytes' water retention in different humidity settings over three days.

FIG. 8. Equivalent circuit models and their corresponding fitting lines in the Nyquist impedance diagrams for stretchable Mg-air, Al-air, and Zn-air batteries.

FIG. 9. Servo motors' speeds. Under no deformations (0-7 s and 19-26 s), three servo motors (from left to right) had 10.71±0.50, 10.36±0.82, and 11.73±0.72 RPM. Under continuous deformations (14-19 s), motor speeds were 10.80±1.06, 10.84±0.42, and 11.80±0.52 RPM. Orange, green, and blue markers represent the left, middle, and right motor respectively.

FIG. 10. Comparative analysis for our stretchable Zn-air batteries with 0-hour and 24-hour shelf lives. The batteries were discharged without stretching, at a constant discharge rate of 10 mA and the size of their electrode-electrolyte contact area is 6.75 cm². The image in the left corner shows the insertion of flexible polypropylene membrane during the battery assembly. It can be pulled out to initiate discharge.

FIG. 11. Fabrication of an elastomeric enclosure for the disclosed stretchable battery. Uncured silicon elastomer was poured into the 3D-printed molds and removed post-curing.

FIG. 12. Fabrication process of the stretchable battery.

FIG. 13. Fabrication of Mckibben actuators.

FIGS. 14A-14B. Design of the soft crawler. FIG. 14A: Exploded view

illustrates all the components inside the crawler. FIG. 14B. The top view shows the two Mckibben actuators having inextensible fibers wrapped in a helical and symmetrical pattern (15° and −15°).

FIG. 15. Design of the pneumatic Stewart platform. The stretchable battery and four Mckibben actuators were arranged in a parallel layout. The bottom view of the top platform shows that on every actuator there is force-sensitive resistor.

### DETAILED DESCRIPTION OF ILLUSTRATIVE EMBODIMENTS

The present disclosure may be understood more readily by reference to the following detailed description of desired embodiments and the examples included therein.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing. All publications, patent applications, patents and other references mentioned herein are incorporated by reference in their entirety. The materials, methods, and examples disclosed herein are illustrative only and not intended to be limiting.

The singular forms “a,” “an,” and “the” include plural referents unless the context clearly dictates otherwise.

As used in the specification and in the claims, the term “comprising” can include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

Unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently of the endpoints. The endpoints of the ranges and any values disclosed herein are not limited to the precise range or value; they are sufficiently imprecise to include values approximating these ranges and/or values.

As used herein, approximating language can be applied to modify any quantitative representation that can vary without resulting in a change in the basic function to which it is related. Accordingly, a value modified by a term or terms, such as “about” and “substantially,” may not be limited to the precise value specified, in some cases. In at least some instances, the approximating language can correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” can refer to plus or minus 10% of the indicated number. For example, “about 10%” can indicate a range of 9% to 11%, and “about 1” can mean from 0.9-1.1. Other meanings of “about” can be apparent from the context, such as rounding off, so, for example “about 1” can also mean from 0.5 to 1.4.

Further, the term “comprising” should be understood as having its open-ended meaning of “including,” but the term also includes the closed meaning of the term “consisting.” For example, a composition that comprises components A and B can be a composition that includes A, B, and other components, but can also be a composition made of A and B only. Any documents cited herein are incorporated by reference in their entireties for any and all purposes.

Any embodiment or aspect provided herein is illustrative only and does not limit the scope of the present disclosure or the appended claims. Any part or parts of any one or more embodiments or aspects can be combined with any part or parts of any one or more other embodiments or aspects.

Wearable sensors, soft robotics, and stretchable electronics have attracted wide attention due to their applications in medical devices, health monitoring, and human-machine interfaces. For many of these applications, the materials and devices that make up these technologies need to stretch, yet the batteries that enable device portability are often rigid and bulky. Ideally, batteries should not sacrifice the compliance or stretchability of the soft systems they power. While ion-conductive polymers have enabled stretchable and flexible electrolytes, achieving stretchable electrodes remains challenging because the best high-capacity electrode materials are solid and assembled in high-volume fractions to maximize specific energy.

Researchers typically adopt two approaches to endow electrodes with stretchability: altering the electrode geometry into a flexible structure capable of deformation under stress, or blending the electrodes with elastic polymers to increase the stretchability of the composite. A popular route to geometrically realize stretchable electrodes is to use the rigid-islands structure, where multiple rigid electrode “islands” are electrically connected by stretchable serpentine “bridges”. As the device stretches, strain is localized in the highly stretchable regions between islands. One has shown that hierarchical buckling physics allowed devices to sustain a tunable axial strain of up to 3 with consistent performance. Alternatively, metamaterial designs allow rigid electrodes to achieve enhanced stretchability by allowing bending or folding at vertices or edges. For example, one has applied laser-cutting techniques to engineer kirigami-based stretchable electrodes. Buckling of the linear-patterned kirigami allowed the battery to sustain a reversible strain of 0.35 and multiaxial stretchability. Metamaterials typically use ultrathin materials to lower the bending strains at vertices or edges. Besides these geometric approaches to stretchability, researchers have also created stretchable 3D conductive composites by blending hard and soft materials. Examples include coating metal on a polymer sponge or blending a silicone matrix with solid electrode particles.

Despite these advancements, prior stretchable battery designs often require demanding preparation processes including digital additive/subtractive manufacturing or specific material-processing conditions. In addition, these approaches have other disadvantages such as low areal capacities, large out-of-plane deformations, delamination from multilayer systems, and permanent distortion from plastic deformation. Due to these constraints, prior stretchable batteries are not ideal power sources for soft electronics and limit translational opportunities.

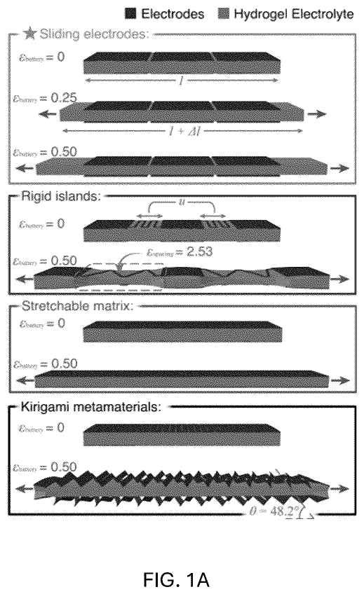

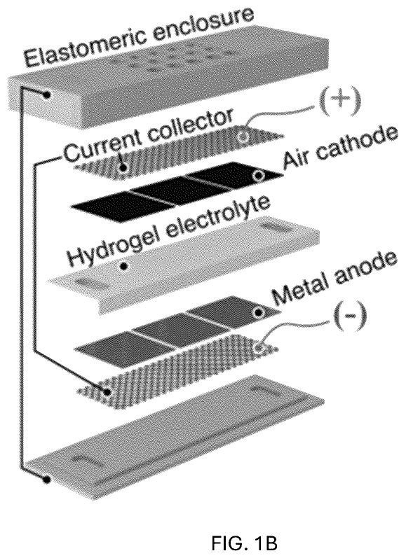

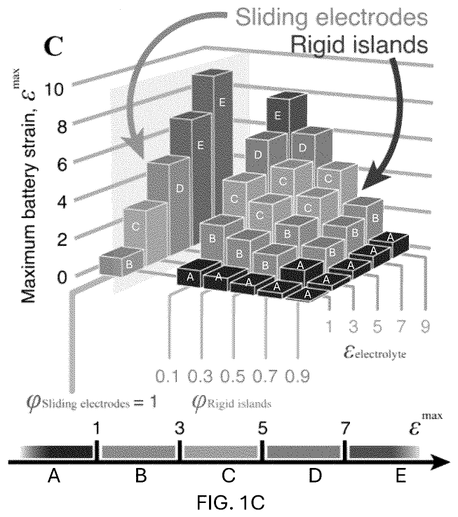

In this disclosure, we introduce a new design approach for stretchable batteries that can leverage the high capacity of rigid electrodes without causing electrode deformation or compromising areal capacity. One feature of this approach is a sliding interface between the rigid electrodes and a highly stretchable polymer electrolyte, as shown in FIG. 1A (Sliding-electrodes). When the sliding-electrodes battery is strained, the internal electrolyte and external enclosure elongate in the direction of the stretch while the electrodes undergo minimal loading and displacement through relative sliding between the electrode and electrolyte interfaces. This sliding mechanism is facilitated by a low friction and unbonded interface between the electrodes and electrolyte. Owing to the electrodes maintaining their shape and a consistent size of the electrode-electrolyte interface, as well as the electrolyte's high ionic conductivity and water content, the battery can provide stable power to electric motors while undergoing bending, stretching, twisting, and heavy impact.

We applied our sliding-electrodes design to three metal-air batteries (MABs) that use rigid metal anode sheets and a compliant, but unstretchable, carbon cloth loaded with platinum, which is commonly used in air cathodes and fuel cells. MABs are promising candidates for powering future electronics because their anodes use abundant raw materials, they have high energy densities, and are fire safe. We compare the maximum achievable strain of our sliding-electrodes battery against existing stretchable designs. We then characterize the mechanical and electrochemical properties of the battery and key components. The sliding interface does not compromise the electrodes' electrochemical performance, and our batteries demonstrate the highest areal capacities among all flexible and stretchable MABs in the literature. Finally, we incorporate our batteries into two soft robots to power their onboard sensors and explain how our approach benefits soft robotic applications.

The sliding-electrodes design not only advances the field of stretchable batteries but also carries broader implications for other batteries and electronics. By reducing the component-level modifications that prior methods often rely upon, this work offers a more streamlined and accessible stretchable battery to engineers.

### 2. Results

### 2.1. Stretchable Battery Design

In prior stretchable battery designs, mechanical forces applied to the battery are transmitted through the electrodes. To enable stretchability, the electrodes are either made geometrically compliant or compliant materials are blended with the rigid electrodes to allow higher device strain under the same loading conditions. In contrast, forces applied to our sliding-electrodes MABs are transduced through the electrolyte and enclosure, while the electrodes and current collectors slide freely between the two.

We utilized finite element (FE) simulations (SIMULIA, Dassault Systèmes) to compare the sliding-electrodes design to three other representative stretchable battery designs: rigid islands, stretchable matrix, and kirigami metamaterials. FIG. 1A illustrates certain trade-offs. To simplify the comparison, we constrained our analysis to electrodes and electrolytes, excluding the enclosure and current collectors. First, in the sliding-electrodes batteries, the maximum strain of the battery is set by the hydrogel electrolyte (equivalently ε_{sliding electrodes}^{max}=ε_{electrolyte}^{max}), since it is the only component stretched in the simulation. In practice, the packaging can also constrain the maximum strain. In the rigid-islands structure, the stretchable substrate attached to the electrodes is constrained by the electrodes' rigidity; therefore, the battery can only stretch between the islands so that the maximum battery strain, ε_{rigid islands}, is inversely proportional to the electrodes' length by

$${ε}_{rigid islands}^{max} = \frac{u}{l} {ε}_{electrolyte}^{max} , \qquad ( 1 )$$

where u is the total spacing between electrodes and l is the length of the battery. The electrode area significantly affects the battery's capacity and power output. We compare the electrode area between designs using the electrode coverage ratio, φ, where

$$φ = \frac{l - u}{l} . \qquad ( 2 )$$

In batteries with sliding electrodes, the spacing between electrodes can be negligible (φ_{sliding electrodes}=1). However, pursuing higher φ_{rigid islands} in batteries with rigid-islands electrodes requires a lower maximum battery strain, ε_{rigid islands}^{max}, by

$${φ}_{rigid islands} = 1 - \frac{{ε}_{rigid islands}^{max}}{{ε}_{electrolyte}^{max}} . \qquad ( 3 )$$

Although electrolytes with larger maximum strain, ε_{electrolyte}^{max}, can mitigate the compromise between electrode area, φ_{rigid islands}, and maximum battery strain, ε_{rigid islands}^{max}, FIG. 1C shows how the maximum strain of a battery is affected by the electrode coverage ratio and the maximum stretchability of the electrolyte for the sliding-electrodes and rigid-island designs. The maximum strain of the sliding-electrodes batteries is equal to the maximum strain of the electrolyte and the areal capacity of sliding-electrodes batteries, φ_{sliding electrodes}, is always superior to the areal capacity of rigid islands, φ_{rigid islands}, assuming they have the same electrode thickness. For example, FIG. 1C shows that for an electrolyte with a maximum strain of 5, a rigid-islands battery whose electrodes cover 50% of the battery area can only be stretched to a maximum strain of 2.5, whereas a sliding-electrodes battery can cover 100% of the area with electrodes and be stretched to a strain of 5. Table 1 (below) shows the detailed values for FIG. 1C.

TABLE 1
Detailed data for the 3D bar chart - Comparison of the maximum
battery strain based on different electrode coverage ratios, φ and
hydrogel electrolyte, ε_{electrolyte}^{max}.

| | ε_{electrolyte}^{max} | | | | |
|---|---|---|---|---|---|
| | 1 | 3 | 5 | 7 | 9 |
| φ_{sliding electrodes} = 1 | 1 | 3 | 5 | 7 | 9 |
| φ_{rigid islands} = 0.1 | 0.9 | 2.7 | 4.5 | 6.3 | 8.1 |
| φ_{rigid islands} = 0.3 | 0.7 | 2.1 | 3.5 | 4.9 | 6.3 |
| φ_{rigid islands} = 0.5 | 0.5 | 1.5 | 2.5 | 3.5 | 4.5 |
| φ_{rigid islands} = 0.7 | 0.3 | 0.9 | 1.5 | 2.1 | 2.7 |
| φ_{rigid islands} = 0.9 | 0.1 | 0.3 | 0.5 | 0.7 | 0.9 |

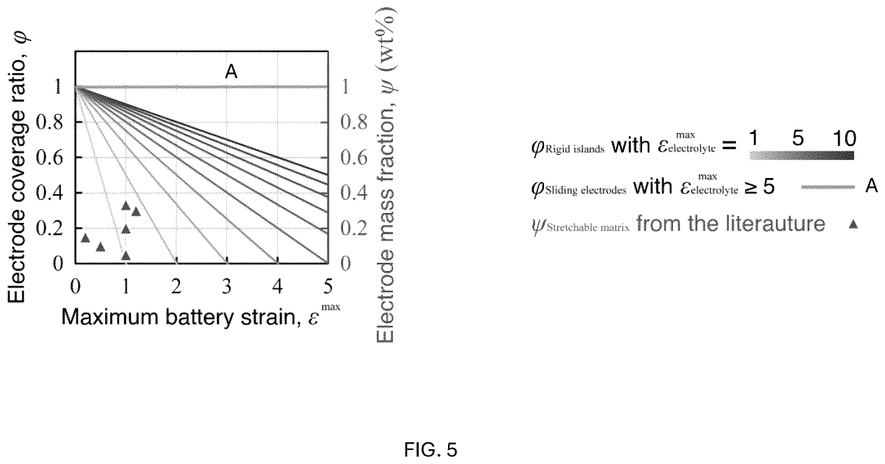

In electrodes made stretchable by blending hard and soft materials, which we call the stretchable matrix design, the polymer matrix sets the stretchability limit. The percentage by weight or volume of the active electrode particles in the matrix, ψ_{stretchable matrix}, determines the battery's specific and areal capacity. Higher maximum strain, ε_{stretchable matrix}^{max}, comes from a lower ψ_{stretchable matrix}, which is usually below 0.4^{[15]}, as plotted on the secondary axis of FIG. 5. In contrast, ψ_{sliding electrodes}=1 in the sliding-electrodes batteries.

Lastly, we compare metamaterial electrodes to these prior designs using a simple kirigami-based electrode, where the strain-induced buckling leads to electrode shape reconfiguration and a tilting angle, θ, at the electrode-electrolyte interface. A popular kirigami structure is the periodic linear pattern shown at the bottom of FIG. 1A, whose θ can sharply increase to 48.2° at ε_{kirigami}^{max}=0.5 and is calculated using

$$θ = {cos}^{- 1} \frac{1}{{ε}_{k irigami} + 1} . \qquad ( 4 )$$

Although there are many designs for stretchable batteries, the design space can be mapped onto the three strategies mentioned above. For instance, it is possible to fabricate the entire battery cell into a kirigami pattern as opposed to just the electrodes, such that every component undergoes the same out-of-plane deformation when stretched. In addition, other foldable electrodes such as wavy structures, honeycombs, and miura-ori patterns can achieve stretchability and flexibility by bending their edges or unfolding tessellated patterns. However, the overall stretchability of these metamaterials has the same trade-offs as the kirigami strategy outlined above, including significant local strains at vertices or edges that lead to fatigue or failure, delamination between layers, and significant out-of-plane deformations that affect their integration and conformability. In contrast, sliding-electrodes batteries have no large out-of-plane deformations, avoid stress concentrations in hard materials, and their electrode-electrolyte contact areas stay the same.

In summary, prior stretchable battery designs often come with significant trade-offs between capacity, reaction interface contact area, and stretchability. As forces are transmitted entirely through the electrolyte in the presented sliding-electrodes design, the electrodes can maximize their areal capacity, energy density, and power density while retaining thin form factors and minimizing stress concentrations.

### Mechanical Characterization

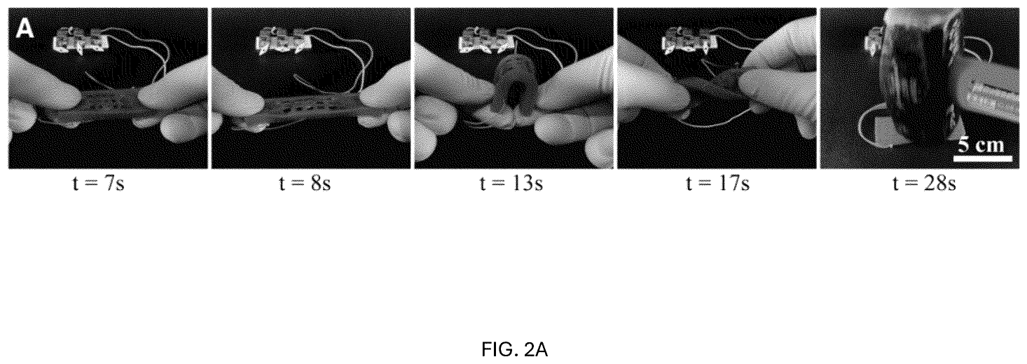

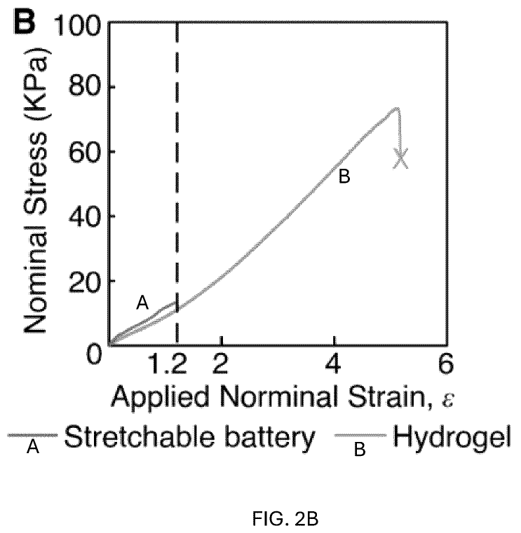

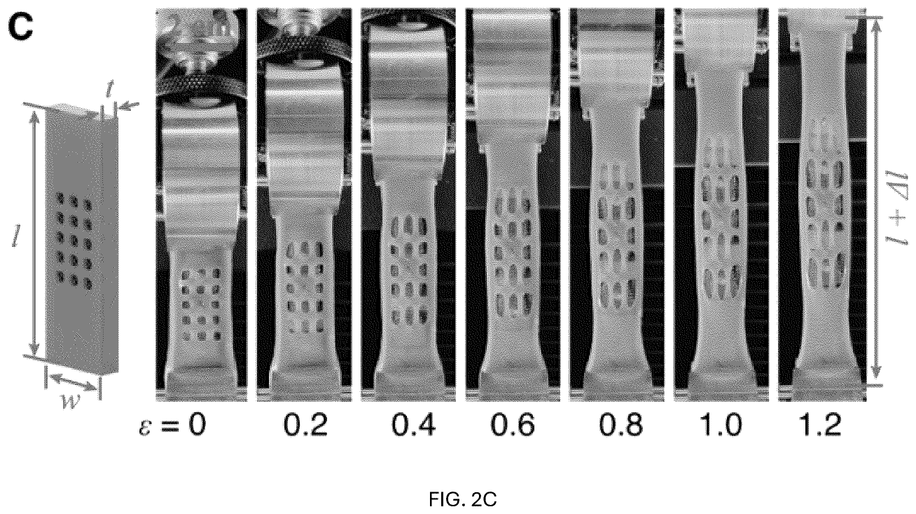

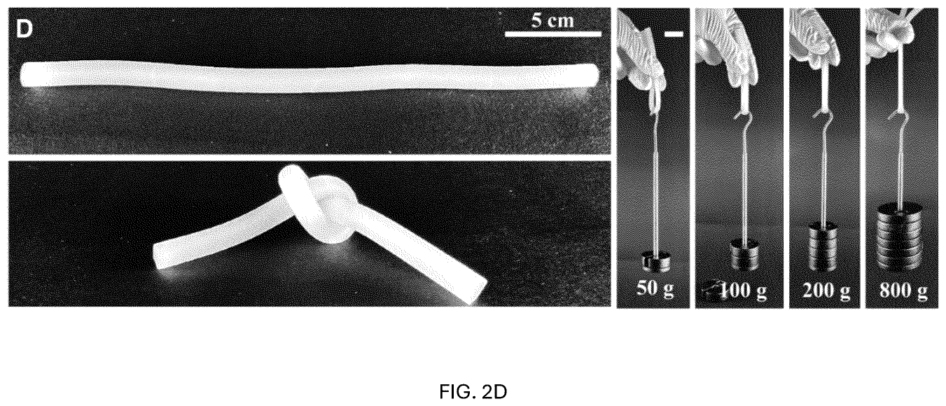

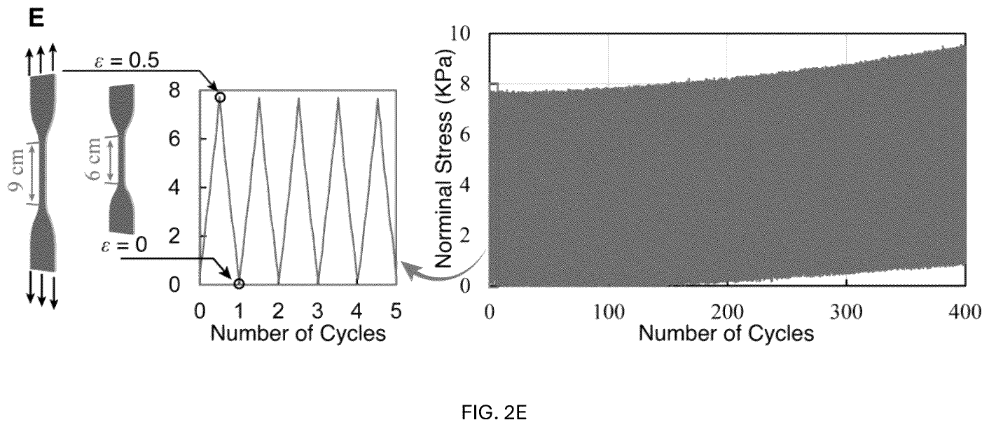

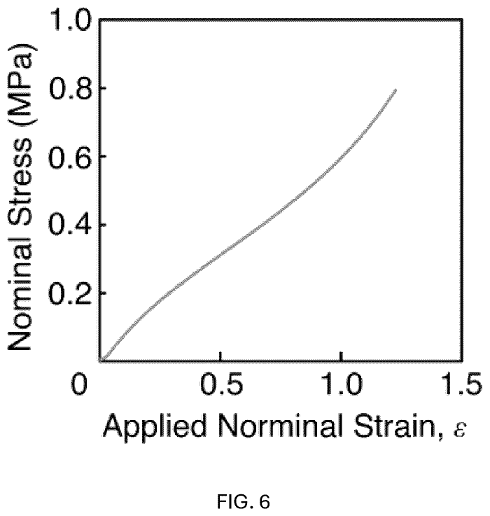

FIG. 2A demonstrates how our stretchable battery continuously powering three servo motors while being subjected to a series of large deformations (stretching, bending, twisting, and impact from a hammer). This resilience results from a combination of our sliding-electrodes design and judicious material selection of battery components. Although it is possible to use a single rigid anode, we diced the anodes into three segments to allow for smooth curvatures during bending. The current collectors are fine copper meshes, which are highly conductive and can resist an axial strain of 1.2 without showing plastic deformation, as shown in FIG. 6. The current collectors are point bonded to the segmented electrodes with conductive epoxy so that they also slide over the hydrogel electrolyte, undergoing strains much smaller than the maximum electrolyte strain, ε_{sliding electrodes}^{max}. FIG. 2C shows images of our batteries stretched to different strains.

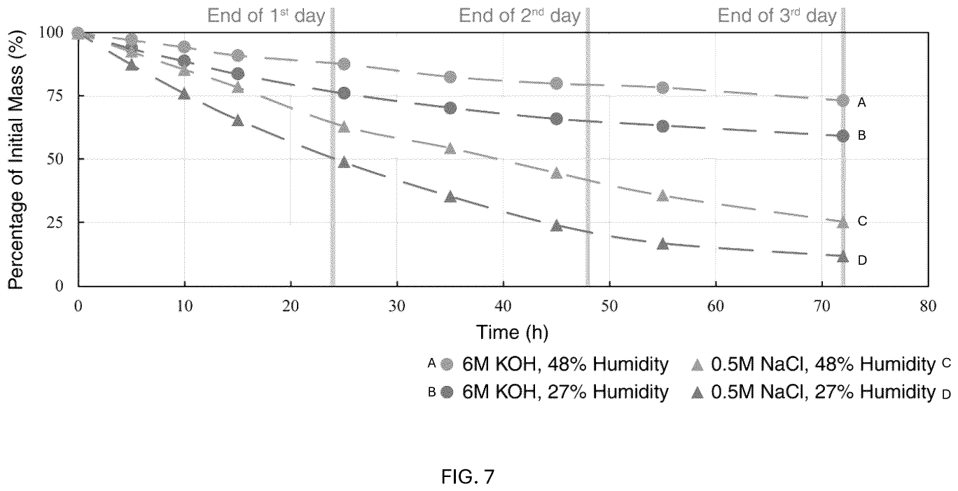

The stretchable hydrogel electrolyte is an interpenetrating polymer network hydrogel made from polyvinyl alcohol (PVA) and polyacrylamides (PAAm). We saturated the hydrogels with either a 6 M potassium hydroxide (KOH) solution or a 0.5 M sodium chloride (NaCl) solution, depending on the chosen anodes. A PVA/PAAm hybrid hydrogel is suitable here due to its high elasticity, chemical stability, low toxicity, and biodegradability^{[22]}. As the hydrogel bares the bulk of the battery loading, the hydrogel's mechanical properties closely align with that of the full battery (FIG. 2B). The stress-strain curve of the hydrogel sample demonstrates its nonlinear, hyperelastic properties, ultimate tensile strength of 73.49 KPa, and a failure strain of 5.06. To visually showcase the hydrogel elasticity, we molded a hydrogel rope, knotted it, and used it to lift a weight of up to 800 g (FIG. 2D). In addition, the hydrogel maintained consistent mechanical properties when cyclically stretched to ε=0.5. FIG. 2E shows, however, that after 130 loading cycles the hydrogel specimen began to exhibit increased plastic deformation, likely due to water loss over time. In a controlled environment of 22° C. and humidity of 48%, KOH and NaCl hydrogel electrolytes retained 73.06% and 25.47% of their initial mass after three days. In a very dry setting (humidity=27%), their retained mass ratios dropped to 59.05% and 11.81%, as shown in FIG. 7. However, when integrated into the stretchable batteries, the hydrogel electrolyte exhibited improved water retention due to the elastomer encapsulation. A packaged Zn-air sliding-electrodes battery lost only 18% of its initial water weight after 60 hours of discharge because electrolyte can only lose water through the vents on the cathode side that are designed to allow oxygen exposure.

Although the elastomeric enclosure helps the hydrogel electrolyte remain stable during discharge, its mechanical properties can limit the stretchability of our battery. Since the enclosure began to show cracks at ε>1.2, especially at locations near the vents due to stress concentrations, we limited the battery strain to 1.2.

### Electrochemical Characterization

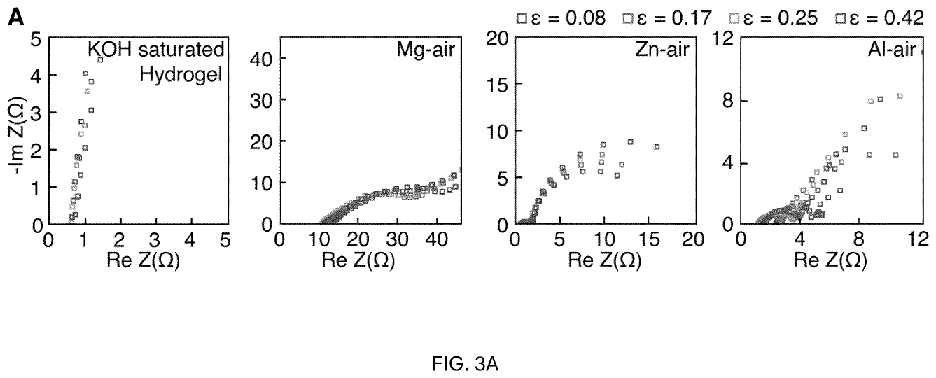

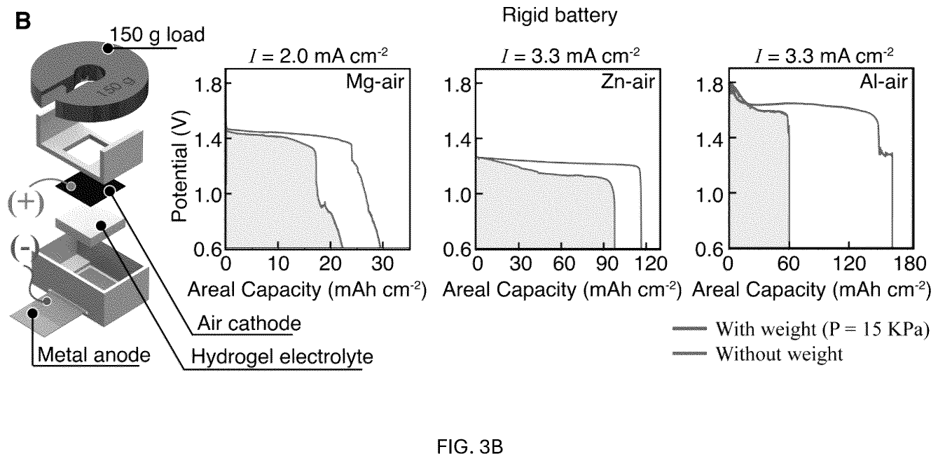

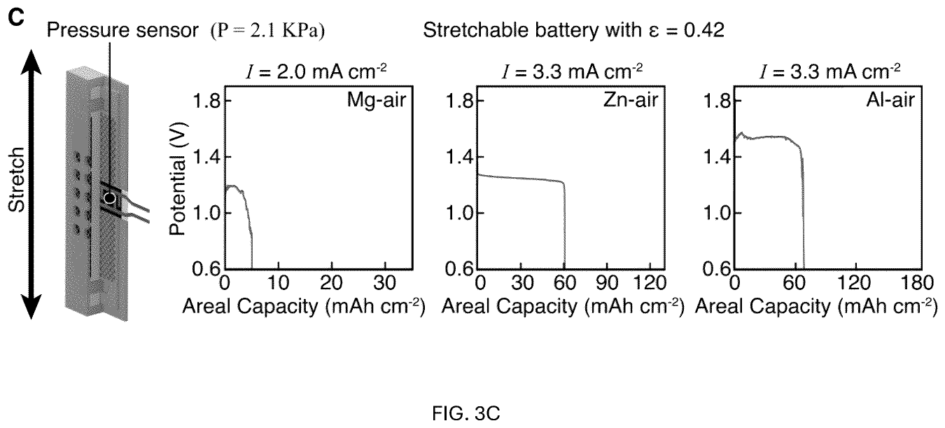

We employed the sliding-electrodes design in MABs with different electrolyte solutions and metal anodes to demonstrate its versatility and effectiveness. For the aluminum-air (Al-air) and zinc-air (Zn-air) cells, we used KOH-saturated hydrogels, while the magnesium-air (Mg-air) cells have NaCl-saturated hydrogels. The KOH-saturated hydrogel had consistent ionic conductivities under various strains, as demonstrated in FIG. 3A (left). Specifically, the hydrogel maintained ionic conductivities of 25.5±1.3 S m⁻¹ across strains ranging from 0 to 0.42. This stability is important for consistent battery discharge under stretching. The NaCl hydrogel had an ionic conductivity of 1.2±0.1 S m⁻¹.

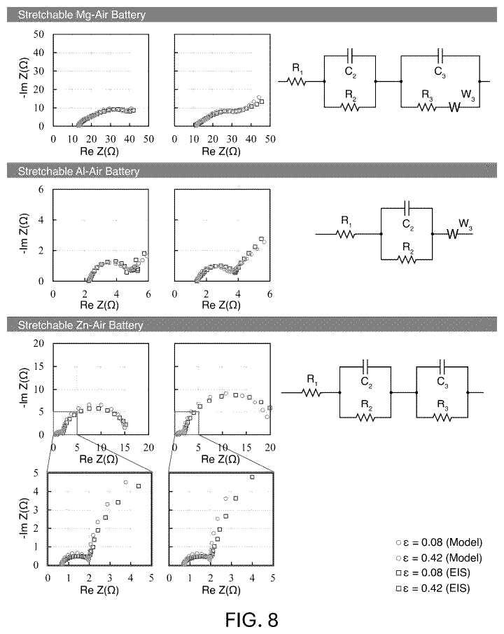

The three stretchable MABs showed different impedances under increasing strains (FIG. 3A). For the Mg-air cell, the bulk resistance started at 13.2 Ω at ε=0.08 and dropped to 10.8 Ω as the strain increased to ε=0.42. Its charge transfer resistance likewise reduced from 36.8 Ω at ε=0.08 to 33 Ω at ε=0.42. In the case of the Zn-air cells, the bulk resistance remained stable at 0.6 Ω throughout the stretch. While the first charge transfer resistances of Zn-air cells remained steady at 1.3 Ω, its second charge transfer resistance climbed from 13.6 Ω at ε=0.08 to 22 Ω at ε=0.42. For the Al-air cell, as the strain increased from 0.08 to 0.17, both bulk and charge transfer resistances decreased, but they rose with further strain, possibly resulting from the buildup of insulating discharge products. The fitting lines and equivalent EIS circuit for our stretchable batteries can be found in FIG. 8 and Table 2 below.

TABLE 2
Fit values for the equivalent circuit models in
FIG. S4 (EIS fitting tool in EC-Lab, BioLogic).

| | R₁ [Ω] | C₂ [F] | R₂ [Ω] | C₃ [F] | R₃ [Ω] | W₃ [Ω · s^{-1/2}] |
|---|---|---|---|---|---|---|
| Mg-air (ε = 0.08) | 13.63 | 16.36e−6 | 6.598 | 0.1789e−3 | 12.65 | 53.12 |
| Mg-air (ε = 0.42) | 11.6 | 27.14e−6 | 4.541 | 0.1863e−3 | 13.9 | 36.82 |
| Al-air (ε = 0.08) | 2.269 | 0.771e−3 | 2.026 | | | 4.76 |
| Al-air (ε = 0.42) | 1.43 | 0.54e−3 | 1.66 | | | 5.132 |
| Zn-air (ε = 0.08) | 0.7375 | 0.9302e−3 | 1.241 | 0.06593 | 18.23 | |
| Zn-air (ε = 0.42) | 0.6891 | 0.7677e−3 | 1.295 | 0.07011 | 13.18 | |

Experiments indicated that placing loads on top of the cells can enhance interfacial contact and improve output power. We, therefore, compared the sliding-electrodes battery's discharge performance to stationary cells in rigid enclosures and with added weight. FIG. 3B shows the rigid battery setup with a 150 g load (15 KPa equivalent). This setup demonstrates the MABs' performance under ideal loaded and unloaded mechanical conditions. Across all our tests, metal-air cells demonstrated enhanced discharge capacities under applied loads. Specifically, at I=2.0 mA cm⁻², the Mg-air cell yielded a capacity of 29.8 mAh cm⁻² with a load, versus 22.2 mAh cm⁻² without. At I=3.3 mA cm⁻², the Zn-air cell reached 117.0 mAh cm⁻² with a load, compared to 98.2 mAh cm⁻² without. The Al-air cell recorded 164.8 mAh cm⁻² with a load and 60.8 mAh cm⁻² without a load. The large difference recorded Al-air capacity comes from hydrogen generation at the interface which impedes ion transport. Applying pressure counteracts this by preventing hydrogen bubble accumulation.

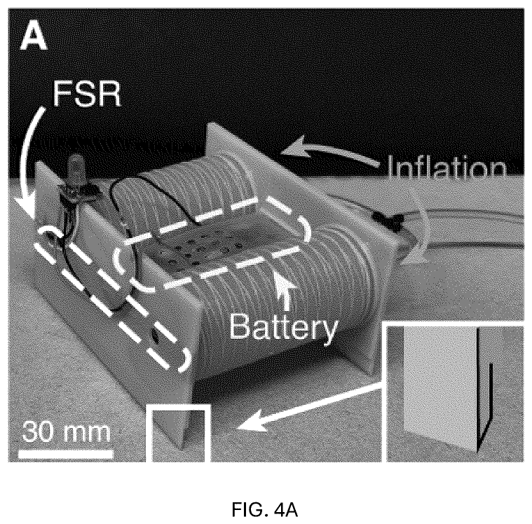

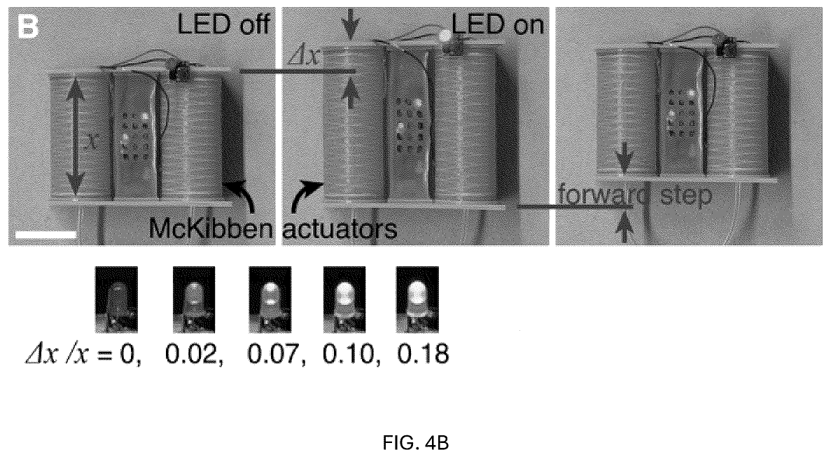

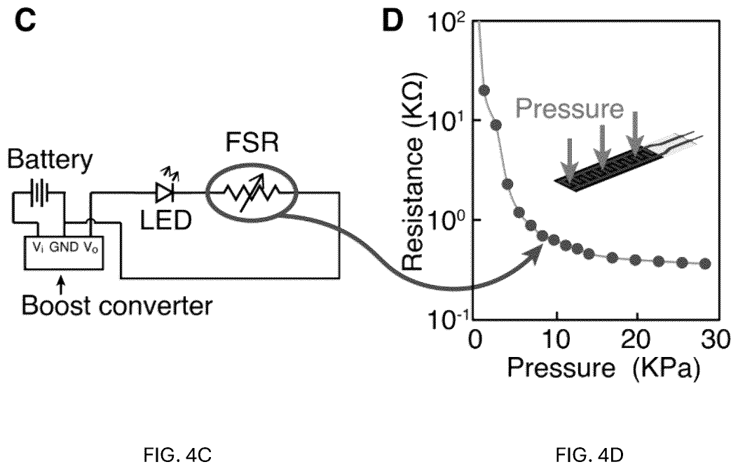

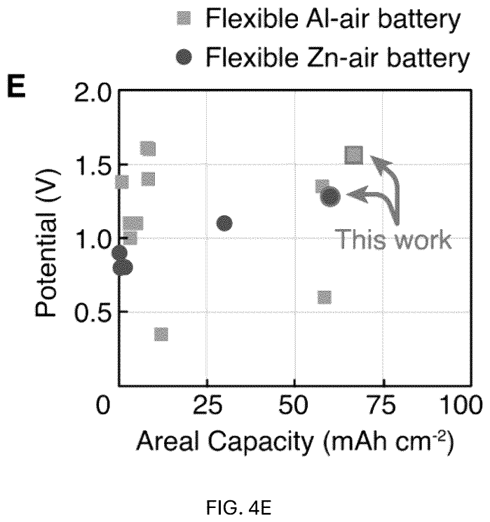

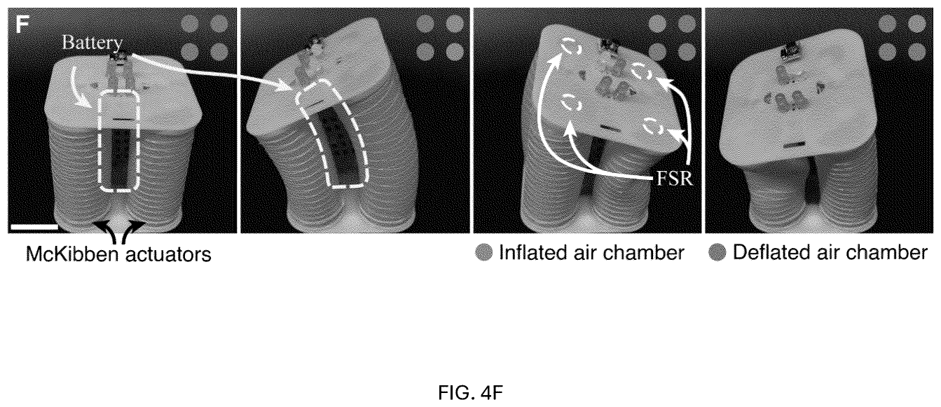

To ensure firm contact at the electrode-electrolyte interface in our stretchable battery, a normal load was introduced to the electrodes by straining the elastomeric enclosure during the assembly. We inserted a thin pressure sensor into the stretchable battery to quantify the normal stress and recorded a value of P=2.1 KPa. FIG. 3C shows the full discharge performance of stretchable metal-air cells held at ε=0.42. The Mg-air cell achieved 5.0 mAh cm⁻² capacity at I=2.0 mA cm⁻². The Zn-air and Al-air cells reached capacities of 60.0 and 68.5 mAh cm⁻² when discharged at I=3.3 mA cm⁻². Although the energy densities of the stretchable batteries were lower than the rigid metal-air cells with external loads (FIG. 3B), our stretchable batteries outperformed state-of-the-art stretchable and flexible MABs, as shown in FIG. 4E. The stretchable Al-air cells had a peak energy density of 104 mWh cm⁻².

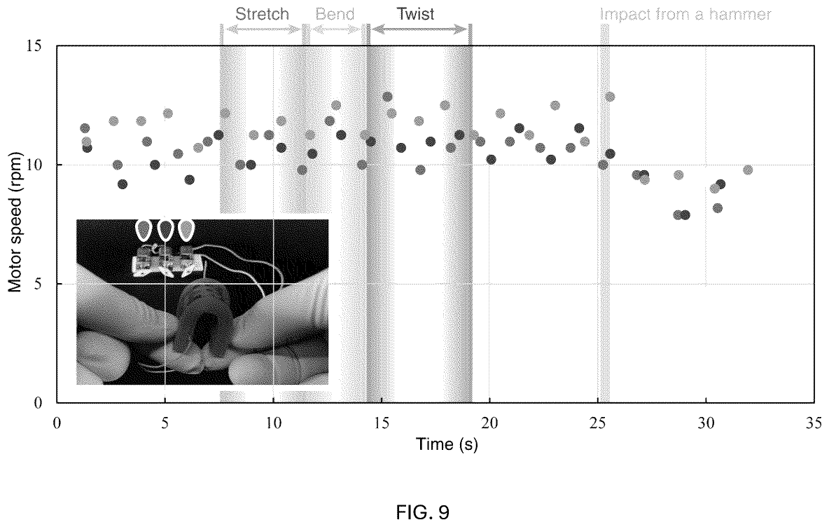

In addition to a high energy density, our stretchable batteries could maintain a consistent output power density under various mechanical deformations. This stability was evaluated by measuring the speed of the servo motors in FIG. 2A. FIG. 9 shows that, when the battery was at rest, the three servo motors (from left to right) rotated at 10.71±0.50, 10.36±0.82, and 11.73±0.72 RPM. When the Al-air stretchable battery powering these motors was subjected to stretching, bending, twisting, and impact with a hammer, the motors held speeds of 10.80±1.06, 10.84±0.42, and 11.80±0.52 RPM, which were comparable to the motor speeds when powered by an undeformed battery. Given that motor speed correlates directly with input voltage and power, the measured RPM data demonstrates the stable discharge of our stretchable battery under various loading conditions.

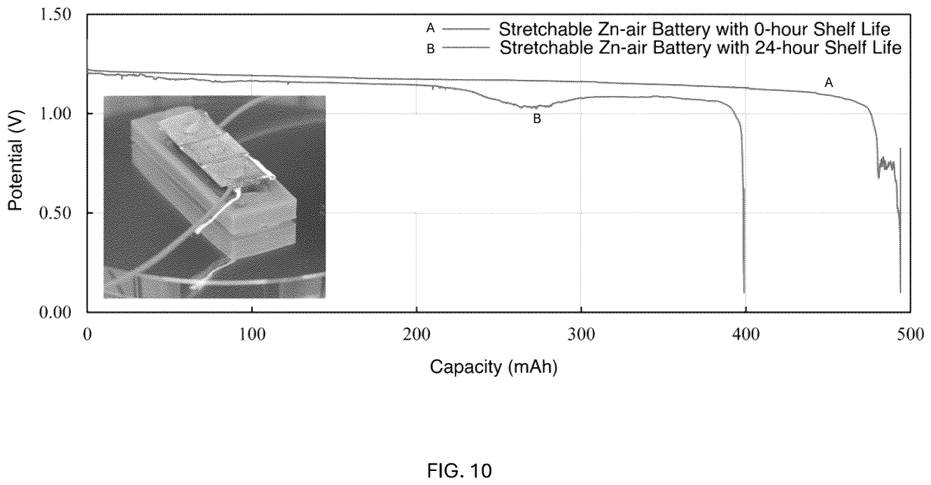

Although the sliding-electrodes batteries were discharged soon after fabrication, their shelf life can be extended by inserting a removeable barrier between the electrode and electrolyte. To demonstrate this, we inserted a 0.14 mm thick flexible polypropylene membrane between the anode and hydrogel electrolyte that could be removed by pulling a tab. FIG. 10 shows the insertion of flexible polypropylene membrane during the battery assembly. After 24 hours of rest, we pulled the polypropylene membrane out of the battery to establish contact between a zinc anode and KOH hydrogel. The battery achieved a capacity of 400 mAh at a discharge rate of 1.5 mA cm⁻², compared to the 480 mAh capacity of a battery immediately discharged after fabrication.

### Integration With Soft Robots

The sliding-electrodes battery can benefit soft robotic applications by endowing better mechanical compliances and higher degrees of freedom. To demonstrate this, we integrated Al-air sliding-electrodes batteries in a soft crawler and a pneumatic Stewart platform. In both systems, the battery powered the onboard circuit and provided visual feedback by triggering LEDs. The movement of both systems rely on a set of Mckibben actuators that extend axially upon inflation. Each Mckibben actuator was equipped with a force-sensitive resistor (FSR) serially connected to an LED and the battery (FIG. 4C). The FSR resistance was inversely proportional to the applied force (FIG. 4D) so that the FSR resistance reduces when the Mckibben actuators inflate and the connected LED's brightness increases, as shown in FIG. 4B. When the actuators deflate, the FSR behaves like an infinite resistor, resulting in an open circuit and unpowered LED. The Mckibben actuators and the sliding-electrodes battery experienced stretching and bending in both demonstrations.

The soft crawler's locomotion depends on its pair of asymmetric feet, whose friction anisotropy allows forward sliding and prevents backward sliding (FIG. 4A). The crawler moved forward with an average step size of 13.8 mm by repeating the following gait: during inflation (LED on), the front end advances as the rear anchors. During deflation (LED off) the front end anchors as the rear advances. The battery was stretched to an axial strain, Δx/x=0.18, in each cycle while consistently powering the onboard circuit. For the pneumatic Stewart platform, the pattern of inflated Mckibben actuators controls the platform's displacement and orientation. Here, only the inflated actuators light up their associated LEDs, leaving the rest off. The sliding-electrodes battery adapted to various shapes and continually illuminated LEDs while the platform maneuvered (FIG. 4F).

### Discussion

In summary, this work introduces a new design for stretchable batteries where stretchability is achieved without compromising performance due to the relative sliding motion between rigid electrodes and a stretchable hydrogel electrolyte. We tested the sliding-electrodes MABs under multiple deformations and integrated them into two soft robotic systems. Based on a series of FE simulations, mechanical testing, and electrochemical characterization, we conclude that the sliding-electrodes design has the following advantages for stretchable batteries: (1) Electrodes and current collectors do not need to be engineered for stretchability which leads to simple integration of available electrodes including those mass manufactured for rigid batteries; (2) Consistent contact between the electrodes and electrolyte enable stable performance during bending, twisting, stretching, and impact; and (3) The electrodes can cover the entire area of the unstretched battery to maximize the battery capacity and power. Notably, the sliding-electrodes batteries demonstrated superior mechanical and electrochemical performance compared to prior flexible and stretchable MABs.

High performance stretchable batteries can be seamlessly integrated with soft robots and preserve their inherent compliance. In particular, sliding-electrodes batteries can benefit soft robots designed for large deformations and unusual form factors which require high electrochemical performance and conformability.

There are several areas where sliding-electrodes batteries can be refined and improved. We can, for example, further boost the battery's capacity with overlapped sliding electrodes so that the reaction area expands upon stretching or integrate a gird of electrodes for multi-directional stretchability. The elasticity and form factors of the battery can also be optimized to cater to specific applications and targeted deformations. Future works can further improve the enclosure materials, which limited the battery's stretchability in the presented design and was also the only non-biodegradable part. A thinner electrolyte could yield a lighter and more flexible battery, benefiting applications like haptics and wearables. In addition, improvements in electrode and electrolyte encapsulation would further improve the battery stability and shelf-life. Beyond MABs, sliding-electrodes can be applied to many solid-state battery chemistries and even enable new approaches for stretchable electronics.

### Methods

### 4.1. Battery Fabrication

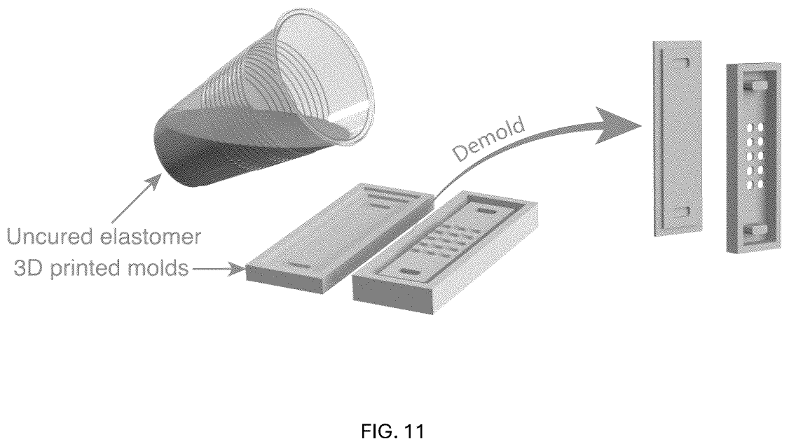

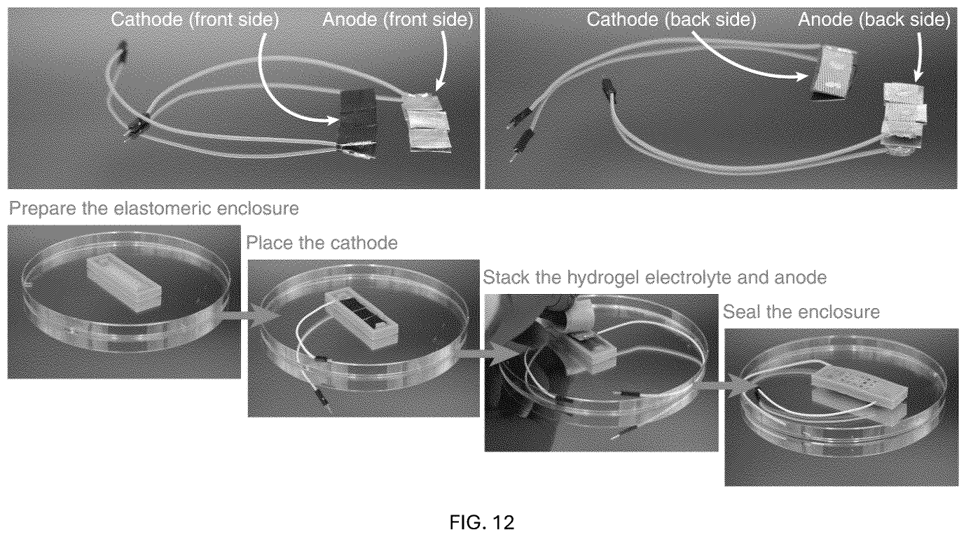

As shown in FIG. 11, we 3D printed two molds (Object30 Pro with VeroGrey, Stratasys), and cast the enclosure of the battery with commercial elastomer (Elite Double 8, Zhermack). Inside the battery, from top to bottom, there is one 15×45 mm copper current collector (Copper screen mesh, SZONEE), three pieces of 15×15 mm air cathodes (2 mg/cm² Platinum Black-Carbon Cloth Electrode, W1S1011, Fuel Cell Store), one hydrogel electrolyte, three 15×15 mm metal anodes, and one 15×45 mm copper current collector. We applied a conductive adhesive (8331D—Silver Conductive Epoxy Adhesive, MG Chemicals) to adhere the electrodes to the current collectors as well as the current collectors to the jumper wires which connect to the external circuits, as shown in FIG. 12 (top). The thickness of Mg, Al, and Zn anodes were 100, 250, and 250 μm. Following the fabrication steps illustrated in FIG. 12 (bottom), we sealed the battery's enclosure with an adhesive agent (Sil-Poxy, SMOOTH ON). The battery enclosure has a thickness of 1 mm and a dimension of 65×20×6 mm.

### 4.2. Synthesis of the Stretchable and Biodegradable Hydrogel Electrolyte

The hydrogel synthesis began by mixing polyvinyl alcohol (12.0 mg mL⁻¹, Mw 146,000-186,000, 99+% hydrolyzed), acrylamide solution (72.0 mg mL⁻¹), and deionized water. The mixture was heated to 100° C. and stirred for 2 hours on a hot plate until it became homogeneous. Subsequently, ammonium persulfate initiator (1.0 mg mL⁻¹) and N,N′-methylenebisacrylamide crosslinker (0.5 mg mL⁻¹) were added to the solution for acrylamide polymerization. The solution was stirred for an additional 10 minutes and then poured into a mold or Petri dish. The hydrogel samples were subjected to three freeze-thawing cycles. Each cycle consisted of 8 hours of freezing at −20° C. followed by 4 hours of thawing at room temperature (22° C.). Before their application in metal-air batteries, the hydrogels were saturated with either 0.5 M sodium chloride or 6 M potassium hydroxide solutions, and lastly cut into 63×18×4 mm pieces.

### 4.3. Finite Element Modeling and Simulation

All the simulations in FIG. 1A were conducted using the commercial FE package Abaqus 2019 (SIMULIA) with the Abaqus/Implicit solver. In models involving electrodes with kirigami or stretchable matrices, the rectangular electrodes were modeled as a 2D deformable shell (15×45×0.2 mm). For sliding-electrodes or rigid-islands designs, the rectangular electrodes were divided into three smaller pieces. In all four designs, the hydrogel electrolytes were modeled as a 3D deformable solid (15×45×3 mm). We applied a linear elastic material model for the electrodes, with a density of 2.7×103 kg m⁻³, Young's modulus of 68,947 MPa, and Poisson's ratio of 0.3. The behavior of the hydrogel electrolyte was simulated based on a nearly incompressible Yeoh hyperelastic model, with a density of 1.0×103 kg m⁻³, Poisson's ratio of 0.495, and material constants calculated based on the experimental uniaxial tensile test. In the implicit dynamic analysis (Quasi-stative application with Nlgeom ON), the electrodes were meshed with linear quadrilateral elements (S4R with seed size=1.5), and the electrolyte was meshed with linear hexahedral elements (C3D8RH with seed size=0.75). In rigid-islands structure or stretchable matrices, TIE constraints were implemented on the interfaces between electrodes and electrolytes. For the other two designs, surface-to-surface contact (Tangential behavior: frictionless, normal behavior: “hard” contact) was applied on the interfaces to allow free sliding motion with no shear force. Symmetric displacement boundary conditions were enforced on both ends of the system to reach the desired strain, with an equally spaced step amplitude.

### 4.4. Mechanical Characterization of the Hydrogel Electrolyte

We evaluated the elasticity and fatigue of the hydrogel electrolyte using a uniaxial testing machine (Instron 6800 series Universal Testing System) with a 50 N load cell. All the tests were performed under uniaxial tensile loading by applying a constant displacement rate of 0.5 mm/s quasi-statically.

### 4.5. Electrochemical Characterization

The impedance and ionic conductivity of the KOH-saturated hydrogel electrolytes were measured between two stainless steel electrodes. Rigid metal-air cells were tested in 3D-printed molds (Object30 Pro, Stratasys). Metal anodes, hydrogel electrolytes, and cathodes were cut into dimensions of 10×10 mm, with an optional 150 g weight placed on top of the molds to facilitate interface contact and discharge performance. Electrochemical impedance spectroscopy (EIS) was performed with a sinusoidal wave perturbation of 10 mV in amplitude. Fitting lines and equivalent circuits were calculated based on the fitting tool in EC-Lab, a software from BioLogic. The stretchable batteries were held at ε=0.42 during the discharge process in FIG. 3. All the tests were performed on a commercial multichannel potentiostat (VMP3, BioLogic Sciences Instruments).

### 4.6. Fabrication of the Mckibben Actuators

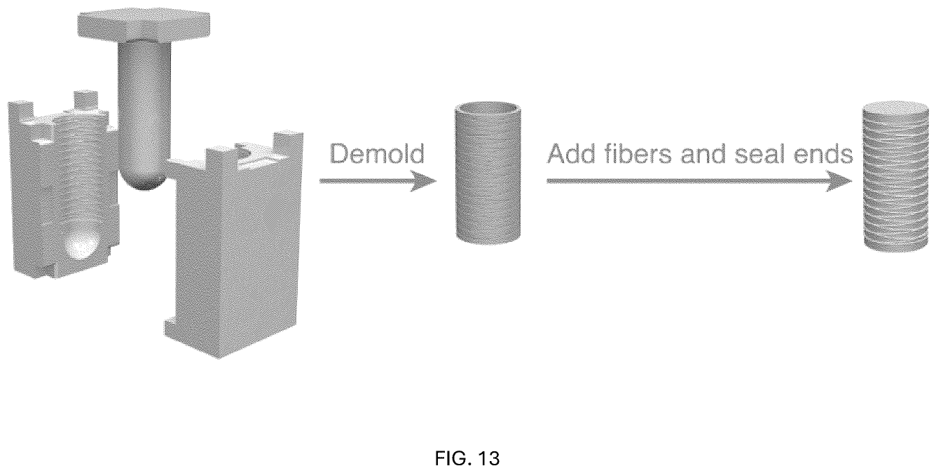

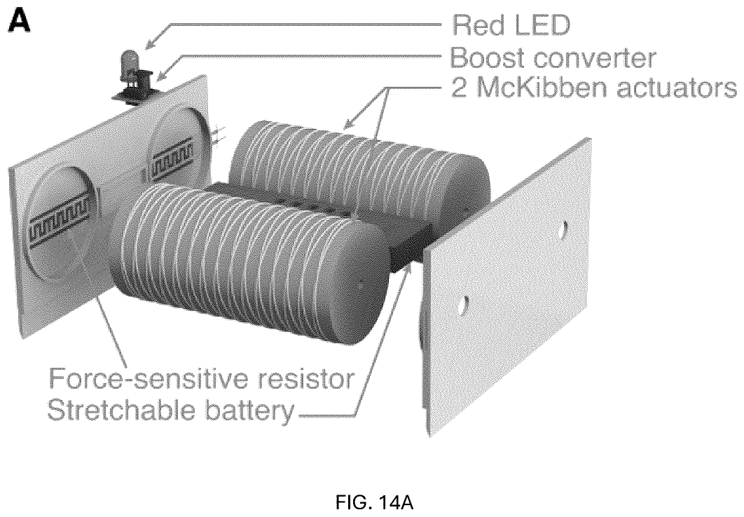

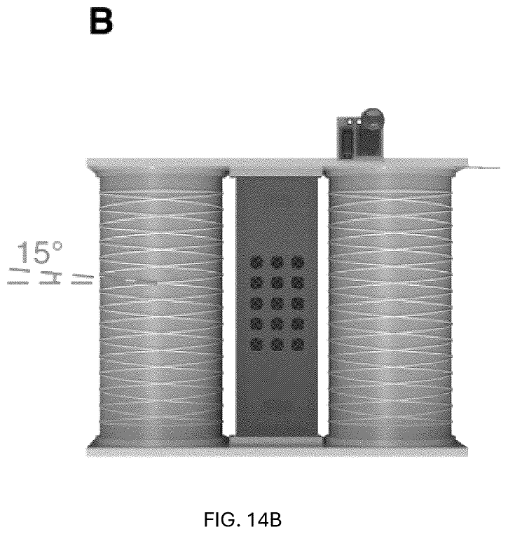

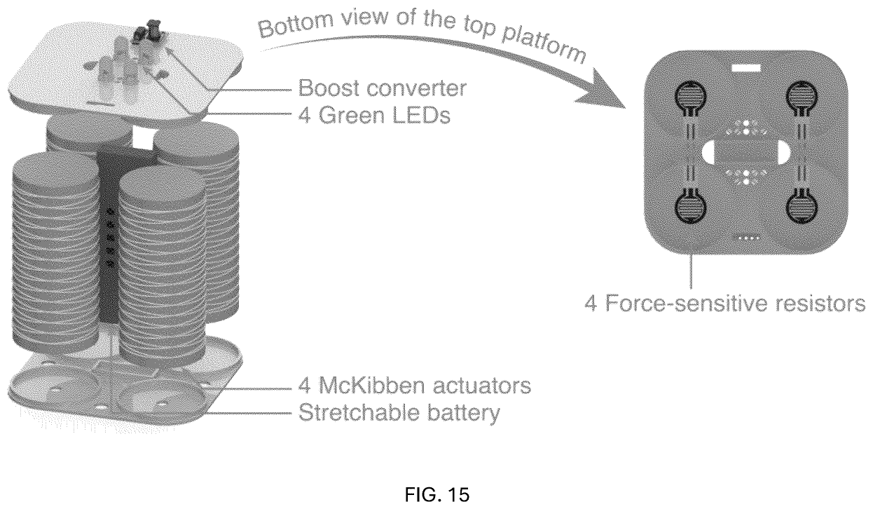

For the Mckibben actuators, we designed, and 3D printed 3 pieces of molds for casting the elastomeric linear actuators, as shown in FIG. 13. Inextensible fibers were wrapped around the actuators in mirrored helix patterns with a 15° tilt. On the top of the fibers, we applied a thin layer of elastomeric glue and sealed both actuator ends with the elastomeric caps. When inflated, the actuators extend axially with radial expansion constrained. The soft crawler (FIG. 14) includes a force-sensitive resistor (ZD10-100, LEANSTAR), a boost converter (CP323, Comidox), a red LED (LED assortment kit for Arduino, ELEGOO), and a pair of Mckibben actuators in parallel, which are inflated and deflated simultaneously. Compared to the crawler, the Stewart platform (FIG. 15) has two more Mckibben actuators and four pressure sensors (RP-C10-ST, Walfront).

### REFERENCES

[1] a) M. Cianchetti, C. Laschi, A. Menciassi, P. Dario, Nature Reviews Materials 2018, 3, 143; b) J. Chen, Y. Shi, B. Ying, Y. Hu, Y. Gao, S. Luo, X. Liu, Materials Horizons 2024, DOI: 10.1039/D3MH01884A.
[2] Y. Liu, M. Pharr, G. A. Salvatore, ACS Nano 2017, 11, 9614.
[3] P. Polygerinos, N. Correll, S. A. Morin, B. Mosadegh, C. D. Onal, K. Petersen, M. Cianchetti, M. T. Tolley, R. F. Shepherd, Advanced Engineering Materials 2017, 19, 1700016.
[4] G. Alici, MRS Advances 2018, 3, 1557.
[5] a) Y. Huang, M. Zhong, F. Shi, X. Liu, Z. Tang, Y. Wang, Y. Huang, H. Hou, X. Xie, C. Zhi, Angewandte Chemie International Edition 2017, 56, 9141; b) W. Liu, M.-S. Song, B. Kong, Y. Cui, Advanced Materials 2017, 29, 1603436; c) T. Ye, L. Li, Y. Zhang, Advanced Functional Materials 2020, 30, 2000077; d) Y. Guo, K. Zheng, P. Wan, Small 2018, 14, 1704497.
[6] W. J. Song, S. Yoo, G. Song, S. Lee, M. Kong, J. Rim, U. Jeong, S. Park, Batteries &amp; Supercaps 2019, 2, 181.
[7] Z. Lv, W. Li, J. Wei, F. Ho, J. Cao, X. Chen, CCS Chemistry 2022, 5, 11.
[8] a) D. G. Mackanic, M. Kao, Z. Bao, Advanced Energy Materials 2020, 10, 2001424; b) D. G. Mackanic, T.-H. Chang, Z. Huang, Y. Cui, Z. Bao, Chemical Society Reviews 2020, 49, 4466; c) C. A. Silva, J. Lv, L. Yin, I. Jeerapan, G. Innocenzi, F. Soto, Y. G. Ha, J. Wang, Advanced Functional Materials 2020, 30, 2002041; d) K. Li, Y. Shuai, X. Cheng, H. Luan, S. Liu, C. Yang, Z. Xue, Y. Huang, Y. Zhang, Small 2022, 18, 2107879; e) L. Wang, Y. Zhang, J. Pan, H. Peng, Journal of Materials Chemistry A 2016, 4, 13419; f) S. Qu, Z. Song, J. Liu, Y. Li, Y. Kou, C. Ma, X. Han, Y. Deng, N. Zhao, W. Hu, C. Zhong, Nano Energy 2017, 39, 101.
[9] S. Xu, Y. Zhang, J. Cho, J. Lee, X. Huang, L. Jia, J. A. Fan, Y. Su, J. Su, H. Zhang, H. Cheng, B. Lu, C. Yu, C. Chuang, T.-I. Kim, T. Song, K. Shigeta, S. Kang, C. Dagdeviren, I. Petrov, P. V. Braun, Y. Huang, U. Paik, J. A. Rogers, Nature Communications 2013, 4, 1543.
[10] a) Y. Bao, G. Hong, Y. Chen, J. Chen, H. Chen, W.-L. Song, D. Fang, ACS Applied Materials &amp; Interfaces 2020, 12, 780; b) R. Sun, B. Zhang, L. Yang, W. Zhang, I. Farrow, F. Scarpa, J. Rossiter, Applied Physics Letters 2018, 112, 251904; c) S. Qu, B. Liu, J. Wu, Z. Zhao, J. Liu, J. Ding, X. Han, Y. Deng, C. Zhong, W. Hu, ACS Applied Materials &amp; Interfaces 2020, 12, 54833; d) A. Amiri, K. Bashandeh, R. Sellers, L. Vaught, M. Naraghi, A. A. Polycarpou, Journal of Materials Chemistry A 2023, 11, 10788; e) Z. Wang, X. Li, Z. Yang, H. Guo, Y. J. Tan, G. J. Susanto, W. Cheng, W. Yang, B. C. K. Tee, EcoMat 2021, 3.
[11] M. Karami-Mosammam, D. Danninger, D. Schiller, M. Kaltenbrunner, Advanced Materials 2022, 34, 2204457.
[12] a) T. Cheng, Y. Zhang, W.-Y. Lai, W. Huang, Advanced Materials 2015, 27, 3349; b) Z. Lv, C. Wang, C. Wan, R. Wang, X. Dai, J. Wei, H. Xia, W. Li, W. Zhang, S. Cao, F. Zhang, H. Yang, X. J. Loh, X. Chen, Advanced Materials 2022, 34, 2202877.
[13] a) D. C. Kim, H. J. Shim, W. Lee, J. H. Koo, D. H. Kim, Advanced Materials 2020, 32, 1902743; b) S. Zhao, J. Li, D. Cao, G. Zhang, J. Li, K. Li, Y. Yang, W. Wang, Y. Jin, R. Sun, C.-P. Wong, ACS Applied Materials &amp; Interfaces 2017, 9, 12147; c) W. Guo, P. Zheng, X. Huang, H. Zhuo, Y. Wu, Z. Yin, Z. Li, H. Wu, ACS Applied Materials & Interfaces 2019, 11, 8567; d) A. V. Kyrylyuk, P. Van Der Schoot, Proceedings of the National Academy of Sciences 2008, 105, 8221; e) S. U. Khan, J. R. Pothnis, J.-K. Kim, Composites Part A: Applied Science and Manufacturing 2013, 49, 26; f) R. Taherian, ECS Journal of Solid State Science and Technology 2014, 3, M26.
[14] a) Y. Wang, H. Y. H. Kwok, W. Pan, Y. Zhang, H. Zhang, X. Lu, D. Y. C. Leung, Electrochimica Acta 2019, 319, 947; b) Y. Wang, H. Y. H. Kwok, W. Pan, H. Zhang, X. Lu, D. Y. C. Leung, Applied Energy 2019, 251, 113342; c) Y. Ma, A. Sumboja, W. Zang, S. Yin, S. Wang, S. J. Pennycook, Z. Kou, Z. Liu, X. Li, J. Wang, ACS Applied Materials & Interfaces 2019, 11, 1988; d) P. Sun, J. Chen, Y. Huang, J.-H. Tian, S. Li, G. Wang, Q. Zhang, Z. Tian, L. Zhang, Energy Storage Materials 2021, 34, 427; e) P. Katsoufis, M. Katsaiti, C. Mourelas, T. S. Andrade, V. Dracopoulos, C. Politis, G. Avgouropoulos, P. Lianos, Energies 2020, 13, 1447; f) S. Liu, J. Ban, H. Shi, Z. Wu, G. Shao, G. Cao, J. Hu, Chemical Engineering Journal 2022, 431, 134283; g) Y. Wang, W. Pan, H. Kwok, X. Lu, D. Y. C. Leung, Energy Procedia 2019, 158, 522; h) C. Zhu, Y. Ma, W. Zang, C. Guan, X. Liu, S. J. Pennycook, J. Wang, W. Huang, Chemical Engineering Journal 2019, 369, 988; i) W. Wang, M. Tang, Z. Zheng, S. Chen, Advanced Energy Materials 2019, 9, 1803628; j) X. Zhong, Z. Zheng, J. Xu, X. Xiao, C. Sun, M. Zhang, J. Ma, B. Xu, K. Yu, X. Zhang, H. M. Cheng, G. Zhou, Advanced Materials 2023, 35, 2209980.
[15] a) L. Hu, M. Pasta, F. La Mantia, L. Cui, S. Jeong, H. D. Deshazer, J. W. Choi, S. M. Han, Y. Cui, Nano Letters 2010, 10, 708; b) W.-J. Song, J. Park, D. H. Kim, S. Bae, M.-J. Kwak, M. Shin, S. Kim, S. Choi, J.-H. Jang, T. J. Shin, S. Y. Kim, K. Seo, S. Park, Advanced Energy Materials 2018, 8, 1702478; c) H. Lee, J.-K. Yoo, J.-H. Park, J. H. Kim, K. Kang, Y. S. Jung, Advanced Energy Materials 2012, 2, 976; d) W. Liu, Z. Chen, G. Zhou, Y. Sun, H. R. Lee, C. Liu, H. Yao, Z. Bao, Y. Cui, Advanced Materials 2016, 28, 3578; e) Y. Song, H. Chen, Z. Su, X. Chen, L. Miao, J. Zhang, X. Cheng, H. Zhang, Small 2017, 13, 1702091; f) H. Li, Y. Ding, H. Ha, Y. Shi, L. Peng, X. Zhang, C. J. Ellison, G. Yu, Advanced Materials 2017, 29, 1700898; g) J. Liang, S. Wang, H. Yu, X. Zhao, H. Wang, Y. Tong, Q. Tang, Y. Liu, Sustainable Energy &amp; Fuels 2020, 4, 2718; h) H.-W. Zhu, J. Ge, Y.-C. Peng, H.-Y. Zhao, L.-A. Shi, S.-H. Yu, Nano Research 2018, 11, 1554.
[16] A. Lamoureux, K. Lee, M. Shlian, S. R. Forrest, M. Shtein, Nature Communications 2015, 6, 8092.
[17] Z. Lv, Y. Luo, Y. Tang, J. Wei, Z. Zhu, X. Zhou, W. Li, Y. Zeng, W. Zhang, Y. Zhang, D. Qi, S. Pan, X. J. Loh, X. Chen, Advanced Materials 2018, 30, 1704531.
[18] W. Liu, J. Chen, Z. Chen, K. Liu, G. Zhou, Y. Sun, M.-S. Song, Z. Bao, Y. Cui, Advanced Energy Materials 2017, 7, 1701076.
[19] a) Z. Lv, Y. Tang, Z. Zhu, J. Wei, W. Li, H. Xia, Y. Jiang, Z. Liu, Y. Luo, X. Ge, Y. Zhang, R. Wang, W. Zhang, X. J. Loh, X. Chen, Advanced Materials 2018, 30, 1805468; b) Z. Shui, X. Liao, Y. Lei, J. Ni, Y. Liu, Y. Dan, W. Zhao, X. Chen, Langmuir 2020, 36, 12954; c) S. Kang, S. Y. Hong, N. Kim, J. Oh, M. Park, K. Y. Chung, S.-S. Lee, J. Lee, J. G. Son, ACS Nano 2020, 14, 3660.
[20] Z. Song, T. Ma, R. Tang, Q. Cheng, X. Wang, D. Krishnaraju, R. Panat, C. K. Chan, H. Yu, H. Jiang, Nature Communications 2014, 5, 3140.
[21] a) S. Babaee, S. Pajovic, A. Rafsanjani, Y. Shi, K. Bertoldi, G. Traverso, Nature Biomedical Engineering 2020, 4, 778; b) A. Rafsanjani, K. Bertoldi, Physical Review Letters 2017, 118.
[22] a) Z. Wang, H. Li, Z. Tang, Z. Liu, Z. Ruan, L. Ma, Q. Yang, D. Wang, C. Zhi, Advanced Functional Materials 2018, 28, 1804560; b) M. Wang, J. Bai, K. Shao, W. Tang, X. Zhao, D. Lin, S. Huang, C. Chen, Z. Ding, J. Ye, International Journal of Polymer Science 2021, 2021, 1; c) S. Alipoori, S. Mazinani, S. H. Aboutalebi, F. Sharif, Journal of Energy Storage 2020, 27, 101072.
[23] a) L. Hu, P. L. Chee, S. Sugiarto, Y. Yu, C. Shi, R. Yan, Z. Yao, X. Shi, J. Zhi, D. Kai, H.-D. Yu, W. Huang, Advanced Materials 2023, 35, 2205326; b) D. Zhou, F. Chen, S. Handschuh-Wang, T. Gan, X. Zhou, X. Zhou, ChemPhysChem 2019, 20, 2139; c) B. Ying, X. Liu, iScience 2021, 24, 103174; d) S. Xu, Z. Zhou, Z. Liu, P. Sharma, Science Advances 2023, 9.
[24] a) M. Wang, U. Joshi, J. H. Pikul, ACS Energy Letters 2020, 5, 758; b) M. Wang, Y. Gao, J. H. Pikul, Advanced Intelligent Systems 2023, 5, 2000255.
[25] B. J. Hopkins, Y. Shao-Horn, D. P. Hart, Science 2018, 362, 658.
[26] E. W. Hawkes, L. H. Blumenschein, J. D. Greer, A. M. Okamura, Science Robotics 2017, 2, eaan3028.
[27] a) T. Q. Trung, N.-E. Lee, Advanced Materials 2016, 28, 4338; b) G. Lee, J. Kim, F. A. Panizzolo, Y. M. Zhou, L. M. Baker, I. Galiana, P. Malcolm, C. J. Walsh, Science Robotics 2017, 2, eaan6708; c) J. R. Franz, Science Robotics 2021, 6, eabm6369.

### ASPECTS

The following aspects are illustrative only and do not limit the scope of the present disclosure or the appended claims. Any part or parts of any one or more Aspects can be combined with any part or parts of any one or more other aspects.

Aspect 1. A flexible battery, comprising: one or more cathodes; one or more anodes; a stretchable electrolyte in ionic communication with the one or more cathodes and the one or more anodes, the stretchable electrolyte defining a cathode contact area with the one or more air cathodes, the stretchable electrolyte defining an anode contact area with the one or more rigid anodes, the stretchable electrolyte optionally comprising a hydrogel; and (1) the one or more cathodes defining a sliding interface with the stretchable electrolyte, (2) the one or more anodes defining a sliding interface with the stretchable electrolyte, or both (1) and (2).

A cathode can be, for example, an air cathode, although this is not a requirement. A stretchable battery according to the present disclosure can also include one or more current collectors; a current collector can also be stretchable. This is not a requirement, however. In some embodiments, a current collector is stretchable, but is less stretchable than the electrolyte. An example arrangement of a stretchable battery according to the present disclosure is provided in FIG. 1B. It should be understood that the disclosed technology can be used with a variety of batteries, including lithium-ion batteries.

An electrolyte can be, for example, a hydrogel. This is not a requirement, however, and an electrolyte can comprise any one or more of polyurethane, polyethylene glycol, polyvinyl alcohol, poly(dimethylsiloxane), polyacrylamide, poly(N-isopropyl acrylamide), hyaluronic acid, gelatin, alginate, chitosan, polysaccharide, cellulose, polyacrylate, polyvalerolactone, polycaprolactone, poly(propylene oxide), poly(2-methacryloyloxyethyl phosphorylcholine), poly(dimethylsiloxane), ureidopyrimidinone, poly(methyl methacrylate), polystyrene, 2-hydroxyethyl methacrylate-acrylamide, poly(styrene)-b-poly(n-butyl acrylate)-poly(styrene), poly(styrene)-b-poly(methyl acrylate)-poly(styrene), and poly(tetramethylene ether) glycol.

An electrode—such as a cathode and/or an anode—can comprise a metal, such as zinc, aluminum, magnesium, sodium, lithium, and their alloys, as non-limiting examples. An electrode can also comprise a composite, such as graphite-lithium composite, silicon-carbon composite, nickel metal hydride, carbon nanotubes, lithium-titanium-oxide, as non-limiting examples. An electrode can also comprise a metal oxide, such as lithium cobalt oxide, lithium manganese oxide, lithium iron phosphate, Lithium nickel cobalt manganese oxide, Lithium nickel manganese oxide, and the like. An electrode can also include a carbon-based material, such as graphite, activated carbons, graphene, carbon nanotubes, and catalysts coating these carbon materials such as platinum, copper, manganese oxide, and the like. An electrode material can be a coherent material; the electrode material can, in some embodiments, comprise particulate material.

Aspect 2. The stretchable battery of claim 1, further comprising a stretchable enclosure enclosing the one or more cathodes, the one or more anodes, and the stretchable electrolyte.

Without being bound to any particular theory or any particular embodiment, a sliding interface may have a coefficient of friction of less than about 0.5. In some embodiments, the coefficient of friction is less than about 0.1.

Aspect 3. The stretchable battery of Aspect 2, wherein the stretchable enclosure permits air passage therethrough. The stretchable enclosure can comprise a porous material; the stretchable enclosure can also comprise apertures formed at least partially therethrough.

Aspect 4. The stretchable battery of any one of Aspects 2-3, wherein the stretchable enclosure is configured to engage with the stretchable electrolyte. An example of such a configuration is shown in FIG. 11.

Aspect 5. The stretchable battery of Aspect 5, wherein the stretchable enclosure is secured or otherwise linked to the stretchable electrolyte. This can be accomplished by, for example, a tab-and-slot arrangement as shown in FIG. 11.

Aspect 6. The stretchable battery of any one of Aspects 1-5, wherein the stretchable battery is configured such that (1) the cathode contact area remains essentially constant with deformation of the stretchable electrolyte, (2) the anode contact area remains essentially constant with deformation of the stretchable electrolyte, or both (1) and (2).

Aspect 7. The stretchable battery of any one of Aspects 1-6, wherein the stretchable enclosure is configured to, when in an unstretched condition, effect (1) exertion of a normal force between the one or more cathodes and the stretchable electrolyte, (2) exertion of a normal force between the one or more anodes and the stretchable electrolyte, or both (1) and (2). This can be accomplished by, for example, incorporating a natural bend, arch, or other such shape into the stretchable enclosure. This can also be accomplished by having features-such as projections-inside the stretchable enclosure, which projections can squeeze the components within the enclosure together.

Aspect 8. The stretchable battery of any one of Aspects 1-7, wherein (1) the stretchable enclosure, when in an unstretched condition, defines an internal space having a first cross-sectional dimension measured in a first direction, (2) the stretchable electrolyte, when in an unstretched condition, defines a corresponding first cross-sectional dimension measured in the first direction, and (3) the first cross-sectional dimension of the stretchable enclosure being lesser than the corresponding first cross-sectional dimension of the stretchable electrolyte. As an example, the interior space within the stretchable enclosure can define a height, and the height of the electrolyte is greater than the height of the interior space within the stretchable enclosure such that the electrolyte and the one or more cathodes and/or the one or more anodes are squeezed together.

Aspect 9. The stretchable battery of any one of Aspects 1-8, wherein the stretchable battery is incorporated into a device. The stretchable battery can also be, for example, a foldable battery that is folded for storage and unfolded for deployment. A stretchable battery can also be used in a folded or partially folded configuration.

Aspect 10. The stretchable battery of Aspect 9, wherein the device is any one or more of a wearable device, a soft robot, a stationary computing device, a mobile computing device, and a display device.

Aspect 11. A method, comprising powering a device that comprises a stretchable battery according to any one of Aspects 1-10.

Aspect 12. A method, comprising effecting operation of a device that comprises a stretchable battery according to any one of Aspects 1-10.

What is claimed:

1. A stretchable battery, comprising:
one or more cathodes;
one or more anodes;
a stretchable electrolyte in ionic communication with the one or more cathodes and the one or more anodes,
the stretchable electrolyte defining a cathode contact area with the one or more cathodes,
the stretchable electrolyte defining an anode contact area with the one or more anodes,
the stretchable electrolyte optionally comprising a hydrogel; and
(1) the one or more cathodes defining a sliding interface with the stretchable electrolyte, (2) the one or more anodes defining a sliding interface with the stretchable electrolyte, or both (1) and (2).

2. The stretchable battery of claim 1, further comprising a stretchable enclosure enclosing the one or more cathodes, the one or more anodes, and the stretchable electrolyte.

3. The stretchable battery of claim 2, wherein the stretchable enclosure permits air passage therethrough.

4. The stretchable battery of claim 2, wherein the stretchable enclosure is configured to engage with the stretchable electrolyte.

5. The stretchable battery of claim 4, wherein the stretchable enclosure is secured to the stretchable electrolyte.

6. The stretchable battery of claim 1, wherein the stretchable battery is configured such that (1) the cathode contact area remains essentially constant with deformation of the stretchable electrolyte, (2) the anode contact area remains essentially constant with deformation of the stretchable electrolyte, or both (1) and (2).

7. The stretchable battery of claim 1, wherein the stretchable enclosure is configured to, when in an unstretched condition, effect (1) exertion of a normal force between the one or more cathodes and the stretchable electrolyte, (2) exertion of a normal force between the one or more anodes and the stretchable electrolyte, or both (1) and (2).

8. The stretchable battery of claim 1, wherein (1) the stretchable enclosure, when in an unstretched condition, defines an internal space having a first cross-sectional dimension measured in a first direction, (2) the stretchable electrolyte, when in an unstretched condition, defines a corresponding first cross-sectional dimension measured in the first direction, and (3) the first cross-sectional dimension of the stretchable enclosure being lesser than the corresponding first cross-sectional dimension of the stretchable electrolyte.

9. The stretchable battery of claim 1, wherein the stretchable battery is incorporated into a device.

10. The stretchable battery of claim 9 wherein the device is any one or more of a wearable device, a soft robot, a stationary computing device, a mobile computing device, and a display device.

11. A method, comprising powering a device that comprises a stretchable battery according to claim 1.

12. A method, comprising effecting operation of a device that comprises a stretchable battery according to claim 1.
